(19) United States
(12) Patent Application Publication
(10) Pub. No.: US 2022/0408661 A1
(43) Pub. Date: Dec. 29, 2022

(54) CANNABIS GROWTH SUPPORT APPARATUS

(71) Applicant: Daniel Michael BITZ, Morinville (CA)

(72) Inventor: Daniel Michael BITZ, Morinville (CA)

(21) Appl. No.: 17/358,094

(22) Filed: Jun. 25, 2021

(51) Int. Cl. A01G 9/26; A01G 22/15; A01G 13/02; A01G 9/18; A01G 9/24; G05B 19/4155

(52) U.S. Cl. CPC A01G 9/26; A01G 22/15; A01G 13/0206; A01G 9/18; A01G 9/246; A01G 9/249; G05B 19/4155; G05B 2219/37375

(57) ABSTRACT

A cannabis growth support apparatus is provided. A cannabis growth support apparatus, for controlling one or more climate systems and monitoring growth of one or more cannabis plants coupled to one or more grow tents, comprising an enclosure housing said one or more climate systems coupled to a power source and a computing device. The computing device having a processor coupled to a computer memory and non-transitory computer readable media and a controller configured to power and regulate the one or more climate systems and a database, coupled to the computing device, for storing climate data from the one or more climate systems. The one or more climate systems is selected from the group consisting of a carbon dioxide enrichment and ventilation system, a humidifier, a dehumidifier, a heater and an air conditioning unit.

### FIELD OF THE INVENTION

The present disclosure relates to a cannabis climate control system more specifically, but not by way of limitation, more particularly to a support apparatus that is attachable to a grow tent to facilitate support and monitor growth of cannabis plants.

### BACKGROUND

Any discussion of the related art throughout the specification should in no way be considered as an admission that such related art is widely known or forms part of common general knowledge in the field.

Currently, cannabis climate controllers, which control the power and regulate growing conditions, require additional components and do not facilitate an all-in-one apparatus. These systems and apparatuses are generally not very compact, convenient and effortless to operate and maintain for the user.

U.S. Pat. No. 9,603,316 B1 (Mansey et al.) discloses a method and system for monitoring and control of hydroponic growing environment. Shortcomings include an inability to compactly combine temperature, humidity and carbon dioxide controls and grow cameras, a lack of portability, an inability to attach to a grow tent and an inability to remotely or manually program the system in coordination with recommended vapor pressure differentials.

U.S. Pat. No. 10,806,100 B1 (Trtilek) discloses a grow cabinet and system for growing plants that maintains optimum growing conditions. Shortcomings include a lack of humidity and carbon dioxide controls, an inability to log data from the humidity and carbon dioxide controls for climate tracking, a lack of alarms coupled to the humidity and carbon dioxide controls for notifying a user of one or more control issues, a lack of portability, an inability to attach to a grow tent, an inability to remotely or manually program the system in coordination with recommended vapor pressure differentials and adjust for different times of the day and seasons.

U.S. Pub. No. 2019/0191639 A1 (Hegyi et al.) discloses an automated indoor cannabis growing facility and methodology for providing a growing apparatus. Shortcomings include a lack of temperature, humidity and carbon dioxide controls and grow cameras, an inability to log data from the temperature, humidity and carbon dioxide controls for climate tracking, a lack of alarms coupled to the temperature, humidity and carbon dioxide controls for notifying a user of one or more control issues, a lack of portability, an inability to attach to a grow tent, an inability to remotely or manually program the system in coordination with recommended vapor pressure differentials and adjust for different times of the day and seasons.

U.S. Pub. No. 2020/0275621 A1 (Maman et al.) discloses an autonomous plant growing system. Shortcomings include a lack of carbon dioxide controls, an inability to log data from the carbon dioxide control for climate tracking, an inability to attach to a grow tent, an inability to remotely or manually program the system in coordination with recommended vapor pressure differentials.

CA Pat. No. 2,889,597 A1 (Helene et al.) discloses a self-sustaining artificially controllable environment within a storage container or other enclose space. Shortcomings include a lack of grow cameras, an inability to attach to a grow tent, a lack of portability, an inability to remotely or manually program the system in coordination with recommended vapor pressure differentials.

CA Pat. No. 2,964,416 A1 (Clugston et al.) discloses a system, apparatus and method for growing marijuana to provide optimal conditions for the growing and harvesting of the marijuana plants. Shortcomings include a lack of temperature, humidity and carbon dioxide controls and grow cameras, an inability to log data from the temperature, humidity and carbon dioxide controls for climate tracking, a lack of alarms coupled to the temperature, humidity and carbon dioxide controls for notifying a user of one or more control issues, a lack of portability, an inability to attach to a grow tent, an inability to remotely or manually program the system in coordination with recommended vapor pressure differentials and adjust for different times of the day and seasons.

CN Pub. No. 103,905,505 A (Shao et al.) discloses an application system monitoring plant growth. Shortcomings include a lack of carbon dioxide control and grow cameras, a lack of portability, an inability to attach to a grow tent and an inability to remotely or manually program the system in coordination with recommended vapor pressure differentials.

WO Pub. No. 2019/237200 A1 (Martin et al.) discloses a precision agriculture system for multivariable optimization of plant growth. Shortcomings include an inability to compactly combine temperature, humidity and carbon dioxide controls and grow cameras, a lack of portability, an inability to attach to a grow tent and an inability to remotely or manually program the system in coordination with recommended vapor pressure differentials.

All documents cited herein are incorporated by reference.

There is a need for a cannabis growth support apparatus for growing cannabis/marijuana/hemp plants that compactly combines an air conditioner, fans, heater, humidifier, dehumidifier and carbon dioxide tank into one device for achieving optimal growing conditions, provides the user with a water level indicator with alarms, is portable, is attachable to a grow tent, contains a grow camera with time-lapse capabilities, employs data logging techniques to track climate, may be either remotely or manually programed in coordination with recommended vapor pressure differentials and may be programmable to adjust for different times of the day and seasons.

### BRIEF SUMMARY

It is the object of the present invention to provide a cannabis growth support apparatus. A cannabis growth support apparatus, for controlling one or more climate systems and monitoring growth of one or more cannabis plants coupled to one or more grow tents, comprising an enclosure housing said one or more climate systems coupled to a power source and a computing device. The computing device having a processor coupled to a computer memory and non-transitory computer readable media and a controller configured to power and regulate the one or more climate systems and a database, coupled to the computing device, for storing climate data from the one or more climate systems. The one or more climate systems is selected from the group consisting of a carbon dioxide enrichment and ventilation system, a humidifier, a dehumidifier, a heater and an air conditioning unit.

In accordance with an embodiment of the invention, the enclosure houses a display module of the computing device capable of displaying and transmitting programming instructions to the one or more climate systems.

In accordance with an embodiment of the invention, the computing device is programmable to adjust for different times of the day and seasons.

In accordance with an embodiment of the invention, the display module is portable.

In accordance with an embodiment of the invention, the computing device is coupled to an application on a smart device capable of displaying and transmitting programming instructions to the one or more climate systems.

In accordance with an embodiment of the invention, the enclosure displays a water level indicator for the dehumidifier.

In accordance with an embodiment of the invention, the enclosure displays a water level indicator for the humidifier.

In accordance with an embodiment of the invention, the enclosure contains a plurality of wheels for mobility.

In accordance with an embodiment of the invention, the enclosure contains a power bar for providing a power source to the one or more climate systems, one or more growth cameras and one or more lights.

In accordance with an embodiment of the invention, the computing device is further coupled to one or more lights.

In accordance with an embodiment of the invention, the one or more lights are set to a timer.

In accordance with an embodiment of the invention, the database further comprises storing light output data from the one or more light.

In accordance with an embodiment of the invention, the computing device is further coupled to one or more grow cameras.

In accordance with an embodiment of the invention, the one or more grow cameras are set to a timer.

In accordance with an embodiment of the invention, the database further comprises storing time-lapse data from the one or more grow cameras.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

The present invention describes a cannabis growth support apparatus that overcomes disadvantages inherent in the known methods and systems of cannabis growth support. The present invention provides a cannabis growth support apparatus, particularly an apparatus, a cannabis growth support apparatus for growing cannabis/marijuana/hemp plants that compactly combines an air conditioner, fans, heater, humidifier, dehumidifier and carbon dioxide tank into one device for achieving optimal growing conditions. As such, the general purpose of the present invention, which will be described subsequently in greater detail, is to provide a new and improved cannabis growth support apparatus which has all the advantages of the cannabis growth systems and none of the disadvantages.

A cannabis growth support apparatus, for controlling one or more climate systems and monitoring growth of one or more cannabis plants coupled to one or more grow tents, presented herein comprises an enclosure housing the one or more climate systems coupled to a power source and a computing device. The computing device possess a processor coupled to a computer memory and non-transitory computer readable media, as well as a controller that is configured to power and regulate the one or more climate systems. Furthermore, a database is coupled to the computing device for storing climate data from the one or more climate systems. The one or more climate systems is selected from the group consisting of a carbon dioxide enrichment and ventilation system, a humidifier, a dehumidifier, a heater and an air conditioning unit. In other embodiments, the cannabis growth support apparatus can be applied to control one or more climate systems and monitor growth of one or more plants known in the art coupled to one or more grow tents.

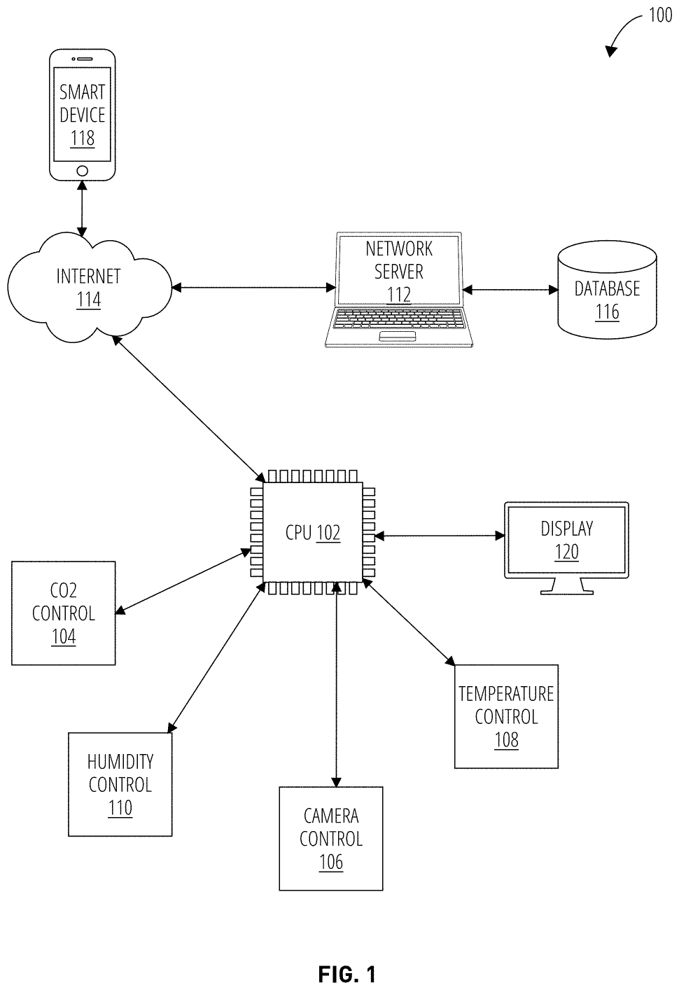

FIG. 1 provides a high level diagram 100 of a cannabis growth support apparatus as in one embodiment. A CPU 102 is coupled to a plurality of climate systems, such as but not limited to a humidifier, a dehumidifier, a carbon dioxide enrichment system, a heater, an air conditioner, one or more growing lights, and one or more growing cameras. The CPU 102 is configured to power and regulate the one or more climate systems, such as the CO2 control 104, the camera control 106, the temperature control 108 and the humidity control 110 shown, via carbon dioxide, temperature and humidity sensors built into the climate systems. The CPU 102 is connected to a network server 112 via the internet 114, where the data obtained from each climate system is sent and stored onto database 116 that is coupled to the network server 112. The temperature control, humidity control and CO2 enrichment data stored in the database 116 are monitored and analyzed to promote successful cannabis growth.

In some embodiments, the computing device is coupled to an application on a smart device 118 capable of displaying and transmitting programming instructions to one or more climate systems. In FIG. 1, users may access the cannabis growth support apparatus system controls and data analysis on a smart device 118, such a cell phone, tablet, computer or other similar device known in the art, connected to the network server 112 via the internet 114. This application can be further programmable to adjust for different times of the day and seasons. In some embodiments, users may access the cannabis growth support apparatus system controls and data analysis on a built in display 120. Users may request information on one or more of the climate systems from the network server 112 for retrieval from the database 116 or input information and programmable growth schedules to network server 112 and to the database 116 for future reference. For example, the user may access a calendar function for setting growth cycles and seasons. In other embodiments, the user employs data logging techniques to track climate, which may either be remotely or manually programed in coordination with recommended vapor pressure differentials to adjust for different times of the day and seasons.

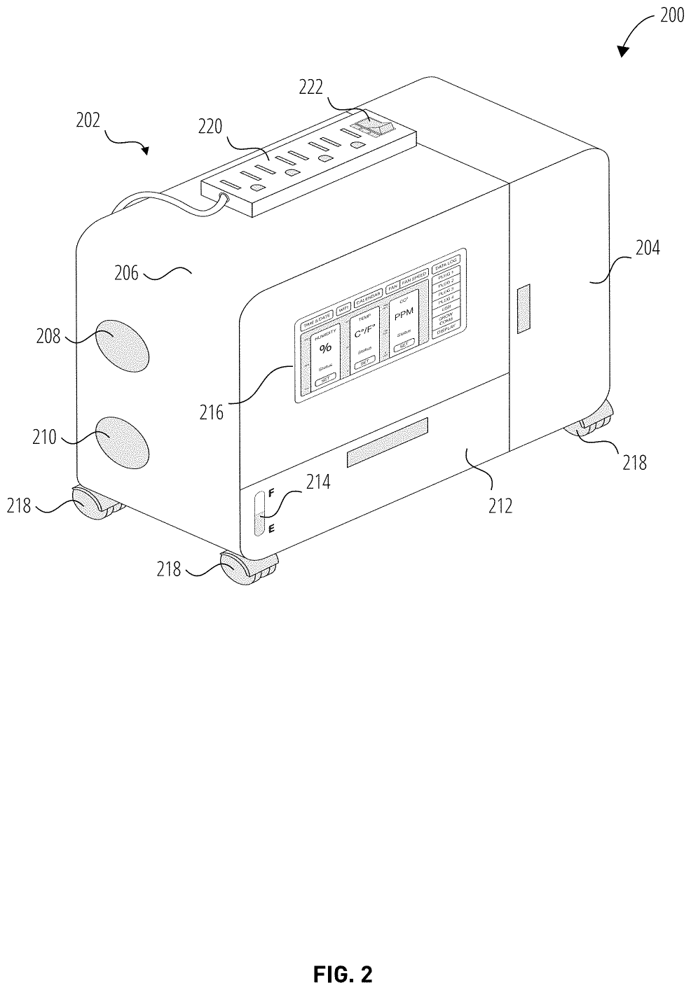

FIG. 2 provides a perspective view 200 of a cannabis growth support apparatus as in one embodiment. The enclosure 202 is shown comprising a CO2 cabinet 204 and an air conditioner compartment 206, which house a carbon dioxide enrichment system and temperature system respectively. An intake duct 208 and output duct 210 are shown on the enclosure 202 which may be connected to a grow tent via ventilation known in the art. The cannabis growth support apparatus will typically sit outside of the grow tent and be connected via ducts as the grow tent is self-contained. Proper carbon dioxide enrichment and climate control are essential for cannabis growth and desired yields. In some embodiments, a heater is included in the air conditioner compartment 206.

The enclosure 202 is shown further comprising a humidity cabinet 212 which may house one or more of a humidifier, a dehumidifier or a combination system. A water level indicator 214 is shown on the humidity cabinet 212 which may be employed to indicate the water level of a built in water reservoir for one or more of the humidifier, dehumidifier or combination systems. In some embodiments, the enclosure 202 may have an accessible drainage slot to the water reservoir for draining the dehumidifier and a cap for filling the humidifier with water.

The enclosure 202 is shown housing a display module 216 with a built in computing device capable of displaying and transmitting programming instructions to one or more climate systems. In some embodiments, the display module 216 is portable. The enclosure 202 is also shown with several wheels 218 for mobility.

On the top of the of the enclosure 202 is a powerbar 220 consisting of a power switch 222 and several outlets for power various climate systems. The powerbar 220 may also be employed for one or more grow lights, fans, grow cameras and may be set to a timer and coupled to the system manually or remotely via WIFI or Bluetooth. In some embodiments, the grow lights are set to a timer and may be coupled to the database 116 for storing light output data. In some embodiments, the grow cameras are set to a timer and may be coupled to the database 116 for storing time-lapse output data.

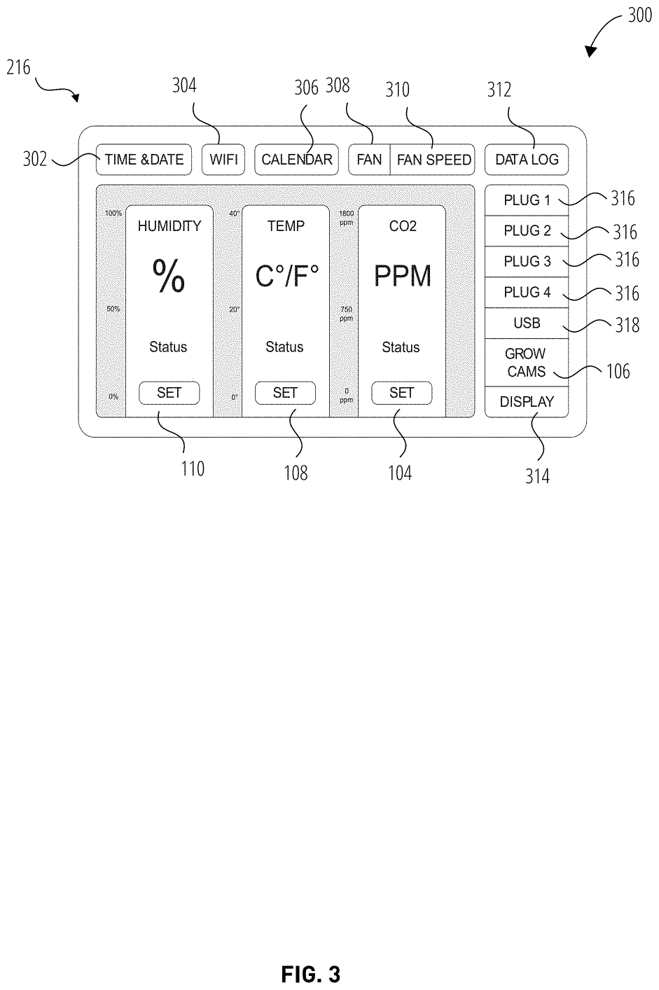

FIG. 3 provides a front view 300 of a display module 216 of the cannabis growth support apparatus as in one embodiment. The user can navigate the display module 216 to receive information on or program instructions to one or more of the climate systems, fans, growing lights and growing cameras. In this examples the control systems include time and date control 302 and calendar control 306 for sophisticated planning of climate systems and growing cycles, WIFI control 304 for remote connection to one or more of the climate systems, fans, growing lights and growing cameras, fan power control 308 and fan speed control 310 for climate system delivery and management, data log 312 for climate systems and growth analysis, display power 314 and power bar control 316 for efficient resource management and system monitoring and USB control 318 for supporting additional applications and system components.

Other embodiments include features such as range settings in coordination with recommended vapor pressure differentials, no positive or negative pressure, four extra WIFI controlled power outlets with timers, WIFI/app controlled with easy to use/read user interface, grow camera with time-lapse capabilities, water level indicators with alarm, stylish black with green accents to match 90% of the grow tents on the market, data logging to track climate throughout your growing period, variable fan speed, power cord organizer that clips onto your tent and programable calendar set “seasons” to simulate natural climates that is Alexa-enabled.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching.

The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

The term “connected” or “coupled to” may include both direct coupling (in which two elements that are coupled to each other contact each other) and indirect coupling (in which at least one additional element is located between the two elements).

As one of ordinary skill in the art will readily appreciate from the disclosure, processes, machines, manufacture, compositions of matter, means, methods, or steps, presently existing or later to be developed, the perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A cannabis growth support apparatus, for controlling one or more climate systems and monitoring growth of one or more cannabis plants coupled to one or more grow tents, comprising:
an enclosure housing said one or more climate systems coupled to a power source and a computing device, said computing device having a processor coupled to a computer memory and non-transitory computer readable media and a controller configured to power and regulate said one or more climate systems; and
a database, coupled to said computing device, for storing climate data from said one or more climate systems,
wherein said one or more climate systems is selected from the group consisting of a carbon dioxide enrichment and ventilation system, a humidifier, a dehumidifier, a heater and an air conditioning unit.

2. The cannabis growth support apparatus of claim 1, wherein said enclosure houses a display module of said computing device capable of displaying and transmitting programming instructions to said one or more climate systems.

3. The cannabis growth support apparatus of claim 2, wherein said computing device is programmable to adjust for different times of the day and seasons.

4. The cannabis growth support apparatus of claim 2, wherein said display module is portable.

5. The cannabis growth support apparatus of claim 1, wherein said computing device is coupled to an application on a smart device capable of displaying and transmitting programming instructions to said one or more climate systems.

6. The cannabis growth support apparatus of claim 5, wherein said computing device is programmable to adjust for different times of the day and seasons.

7. The cannabis growth support apparatus of claim 1, wherein said enclosure displays a water level indicator for said dehumidifier.

8. The cannabis growth support apparatus of claim 1, wherein said enclosure displays a water level indicator for said humidifier.

9. The cannabis growth support apparatus of claim 1, wherein said enclosure contains a plurality of wheels for mobility.

10. The cannabis growth support apparatus of claim 1, wherein said enclosure contains a power bar for providing a power source to said one or more climate systems, one or more growth cameras and one or more lights.

11. The cannabis growth support apparatus of claim 1, wherein said computing device is further coupled to one or more lights.

12. The cannabis growth support apparatus of claim 11, wherein said one or more lights are set to a timer.

13. The cannabis growth support apparatus of claim 11, wherein said database further comprises storing light output data from said one or more light.

14. The cannabis growth support apparatus of claim 1, wherein said computing device is further coupled to one or more grow cameras.

15. The cannabis growth support apparatus of claim 14, wherein said one or more grow cameras are set to a timer.

16. The cannabis growth support apparatus of claim 14, wherein said database further comprises storing time-lapse data from said one or more grow cameras.
